(19) United States
(12) Patent Application Publication
(10) Pub. No.: US 2006/0174004 A1
(43) Pub. Date: Aug. 3, 2006

(54) System and method for optimizing access network authentication for high rate packet data session

(75) Inventor: Sarvesh Asthana, San Diego, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/343,631

(22) Filed: Jan. 31, 2006

Related U.S. Application Data
(60) Provisional application No. 60/593,625, filed on Jan. 31, 2005.

(51) Int. Cl. G06F 15/173

(52) U.S. Cl. 709/225

(57) ABSTRACT

Provided are improved systems, methods, devices, and computer program products for optimized access network authentication of an access terminal on an access network supporting negotiation of an application level protocol for the air link or implementing access network authentication functionality with an extended packet-oriented RLP. A packet-oriented air link application layer protocol supporting the functionality of CHAP authentication, such as an application level authentication protocol operating on an HRPD EvDO Rev A access network or an extended packet-oriented RLP operating on an enhanced HRPD EvDO Rev A access network, can be used for authenticating an access terminal on the access network without setting up a PPP session for access network authentication, such as setting up a PPP session with the SC/MM network entity by doing LCP and CHAP just to do terminal authentication using the protocols of the PPP protocol suite. Embodiments of the present invention avoid the need for setting up a PPP session for access network authentication, thus, saving air link resources and time during the authentication process for the access terminal and access network and reducing the complexity of access terminal implementations by avoiding the need for multiple PPP sessions.

### CROSS-REFERENCE TO RELATED APPLICATION

This application claims priority to and the benefit of the filing date of U.S. Patent Application 60/593,625, entitled “System and Method for Optimizing Access Network Authentication for High Rate Packet Data Session,” filed Jan. 31, 2005, the contents of which are incorporated by reference.

### FIELD OF THE INVENTION

The present invention relates generally to systems and methods for authenticating an access terminal in a wireless network and, more particularly, to systems, methods, devices, and computer program products for optimizing authentication of an access terminal in a high rate packet data access network data session on the application layer of the air link.

### BACKGROUND

Typically when an access terminal (AT) connects to an access network (AN), or radio access network (RAN), the access network authenticates the access terminal and assigns a unique identifier for the access terminal on the access network. In cdma2000 access networks, the authentication and unique identifier assignment is performed by the Mobile Switching Center (MSC)-Home Location Registry (HLR) or -Visiting Location Registry (VLR) part of the cdma2000 access network. High Rate Packet Data (HRPD) access networks have recently been developed; however, HRPD access networks do not incorporate an MSC-HLR or -VLR. Thus, a different procedure was established for authentication in HRPD access networks.

In a conventional HRPD access network the authentication is performed by an access network (AN) authentication, authorization, and accounting (AAA) server (the AN AAA) using an A12 interface. When an access terminal (AT) negotiates a new session with the access network, the access terminal negotiates a point-to-point protocol (PPP) session above the physical layer of the Open Systems Interconnected (OSI) model, i.e., above the air link level of the HRPD access network, for performing access network authentication. The PPP session setup uses Link Control Protocol (LCP) between the access terminal and an access network controller (ANC) or similar access network entity performing session control/mobility management (SC/MM) functionality such as at a packet control function (PCF) entity. This PPP session setup uses LCP to negotiate the PPP session characteristics such as use of Challenge Handshake Authentication Protocol (CHAP) to perform access network authentication. The purpose of the PPP session is to facilitate CHAP authentication, particularly to send a CHAP challenge request to the access terminal. A CHAP challenge response is used in an A12 Access Request on the A12 interface to authenticate the access terminal with the AN AAA and to assign a unique identifier to the access terminal, such as an IMSI. Additional information can be found on the authentication procedure in Interoperability Specification (IOS) for High Rate Packet Data (HRPD) Access Network Interfaces-Rev A., 3GPP2 A.S0007-A, rev. A, ver. 2.0 (May 2003).

Using a PPP session for access network authentication, with CHAP can cause latency in the authentication of an access terminal on an access network and uses valuable air link resources. The PPP session used for access network authentication requires the access terminal and the access network to establish, maintain, and support the additional communication stream that requires dedicated use of one of the four streams defined in data optimized (DO) architecture.

### SUMMARY

Embodiments of the present invention provide systems, methods, devices, and computer program products for optimizing access network authentication on the HRPD air link. An exemplary method of an embodiment of the present invention may include the steps of negotiating an access network authentication protocol for the air link application layer during negotiation of a communication session between the access terminal and the access network, receiving an access network authentication challenge request message, transmitting an access network authentication challenge response message, and receiving an access network authentication status indication message. Rather than the step of negotiating an access network authentication protocol for the air link application layer, a method of an embodiment of the present invention may include implementing authentication with a packet-based application layer protocol like RLP during negotiation of a communication session between the access terminal and the access network.

Typical exemplary methods of implementing an embodiment of the present invention include either, a first mode, defining a new data optimized (DO) air link application protocol (AN Auth Protocol) on top of octet-based RLP or, a second mode, using packet-based RLP where the packet-based RLP is further enhanced to include the authentication functionality. In case of packet-based RLP, defined in the enhanced multiflow packet application, an embodiment of the present invention may be implemented without defining the AN Auth Protocol, but incorporating the functionality of the AN Auth Protocol into the packet-based RLP to have the packet-based RLP provide the access network authentication functionality.

Another exemplary embodiment of a method of the present invention may include the steps of negotiation an access network authentication protocol for the air link application layer during negotiation of a communication session between the access terminal and the access network, transmitting an access network authentication challenge request message, receiving an access network authentication challenge response message, and transmitting an access network authentication status indication message. Rather than the step of negotiating an access network authentication protocol for the air link application layer, a method of an embodiment of the present invention may include the step implementing authentication with a packet-based application layer protocol during negotiation of a communication session between the access terminal and the access network. The method may further include the step of receiving an A14 authentication challenge message which prompts the transmission of the access network authentication challenge request message. The method may further include the step of transmitting an A14 authentication challenge message in response to receiving the access network authentication challenge response message.

Embodiments of systems of the present invention can function according to these described methods. A system can either establish a new application layer protocol, access network Authentication Protocol (AN Auth Protocol), on top of octet-based RLP of an HRPD Evolution Data Optimized Revision A (EvDO Rev A) access network and, thereby, provide the authentication functionality performed by CHAP on a separate PPP session, or a system can implement the authentication functionality over packet-based RLP of an HRPD EvDO Rev A access network with enhanced multiflow packet application protocol. Following the first mode, when originating an HRPD EvDO Rev A session, the access terminal negotiates the AN Auth Protocol as part of the multiflow packet application negotiation of the HRPD EvDO Rev A access network. For example, in one embodiment of a system of the present invention, rather than establishing an air link stream and negotiating LCP and CHAP as part of the PPP setup with the SC/MM network entity, the system can take advantage of the multiflow packet application functionality of an HRPD EvDO Rev A access network to negotiate a virtual stream and the capability of the data optimized (DO) architecture, where it is possible to negotiate a new application level protocol such as an access network authentication protocol (AN Auth Protocol) on top of octet-based RLP. Alternatively, a system can implement authentication functionality over packet-based RLP of enhanced multiflow packet application of enhanced EvDO Rev A. Although multiple streams would still be needed, there is no additional PPP setup overhead for authenticating the access terminal on the access network.

These characteristics, as well as additional details, of the present invention are further described herein with reference to these and other embodiments.

### BRIEF DESCRIPTION OF THE DRAWING(S)

Having thus described the invention in general terms, reference will now be made to the accompanying drawings, which are not necessarily drawn to scale, and wherein:

FIG. 1 is a call flow diagram of an embodiment of the present invention;

FIG. 2 is a block diagram of an entity of an embodiment of the present invention; and

FIG. 3 is a functional diagram of an entity of an embodiment of the present invention.

### DETAILED DESCRIPTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

While a primary use of embodiments of the present invention may be in the field of mobile terminal services and applications, it will be appreciated from the following description that the invention is also useful for various other types of wireless services and applications. Further, while a primary use of access terminals, or mobile stations, may be in the field of mobile phone technology, it will be appreciated from the following that many types of devices that are generally referenced herein as access terminals, including, for example, mobile phones, pagers, handheld data terminals and personal data assistants (PDAs), portable personal computer (PC) devices, electronic gaming systems, global positioning system (GPS) receivers, satellites, and other portable electronics, including devices that are combinations of the aforementioned devices may be used with embodiments of the present invention.

Exemplary embodiments of the present invention are described herein with particular reference to a High Rate Data Packet (HRDP) Evolution Data Optimized Revision A (EvDO Rev A) access network; however, it will be appreciated from the following description that the invention may be used in other access networks where the link layer has the ability to recognize packets. That is, embodiments of the present invention are independent of the particular access network providing the communication channel for the access terminal and may be used with other access networks such as those that support multiflow packet application protocol or enhanced multiflow packet application, thus, supporting use of a packet-oriented application protocol like packet-oriented Radio Link Protocol (RLP). Such an access network supports access network authentication of an access terminal of the present invention without PPP setup for access network authentication. For example, other versions of HRPD access network could support an embodiment of the present invention.

Embodiments of the present invention take advantage of the fact that HRPD EvDO Rev A access networks can negotiate a multiflow packet application or enhanced multiflow packet application. The Rev A versions of HRPD EvDO added support for negotiation of application layer protocols at session negotiation. The air link application layer supports packet-specific streams. This new mechanism at the air link application layer means that the radio link protocol (RLP) can be an octet-based stream (octet-based RLP) and supports negotiation of packet applications such as AN Auth Protocol or a packet-based stream (packet-based RLP) and supports integration of additional functionality as part of enhanced multiflow packet application protocol. Packet-oriented RLP allows for definition of a protocol within the air link application layer by defining a frame structure for the protocol. Thus, when an access terminal negotiates a new session with an HRPD EvDO Rev A access network, the access terminal can negotiate an access network authentication protocol (AN Auth Protocol) for performing the authentication procedures previously performed using a PPP session by setting up LCP and CHAP. This reduces the complexity of the implementations on the access terminal because the access terminal does not have to implement multiple PPP sessions that are different in state machine implementations, one for access network authentication requiring LCP and CHAP and another for normal data traffic requiring LCP, CHAP, and network control protocol (NCP).

The following message formats provide an Access Network Authentication (AN Auth) Protocol of an embodiment of the present invention.

| | |
|---|---|
| Field | Length (Bits) |

ANAuthChallengeReq Message

| | |
|---|---|
| MessageID | 8 |
| Identifier | 8 |
| Challenge Size | 8 |
| Challenge Value | variable |

ANAuthChallengeResp Message

| | |
|---|---|
| MessageID | 8 |
| Identifier | 8 |
| Challenge Response Size | 8 |
| Challenge Response Value | Variable |

ANAuthStatusInd Message

| | |
|---|---|
| MessageID | 8 |
| Identifier | 8 |
| Status (Success or Failure) | 8 |
| Identifier Length | 8 |
| Terminal Identifier (IMSI) | Variable |

Similarly, an enhancement to HRPD EvDO Rev A (enchanced EvDO Rev A) provides an enhanced multiflow packet application protocol that permits the definition of access network authentication functionality over packet-based RLP. In an embodiment of the present invention using enhanced multiflow packet application protocol of enhanced EvDO Rev A, an embodiment of the present invention may also be implemented without defining the AN Auth Protocol, but incorporating the functionality of the AN Auth Protocol over the packet-based RLP to have the packet-based RLP provide the access network authentication functionality.

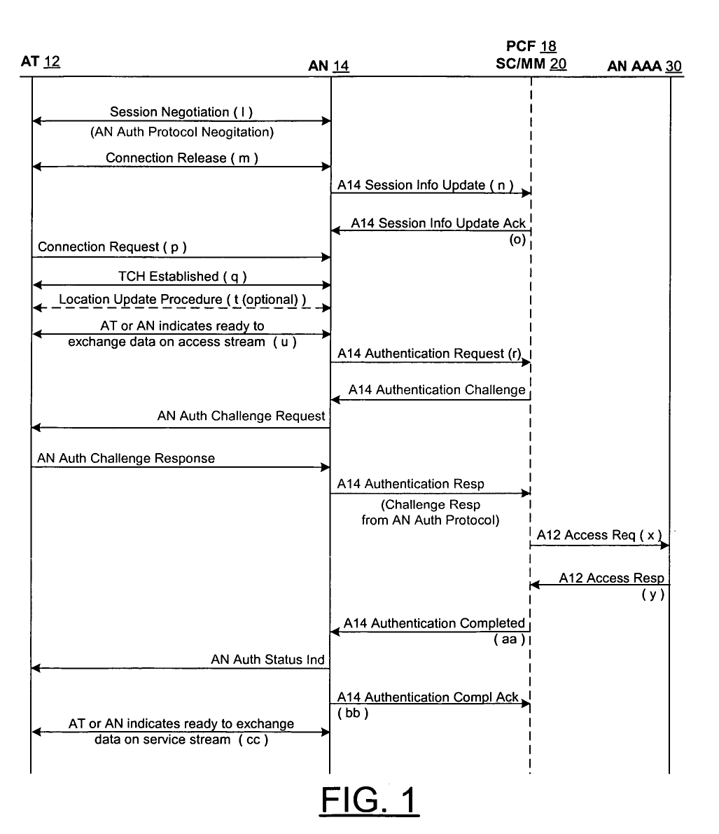

An embodiment of optimized access network authentication of the present invention typically will follow the conventional HRPD EvDO Rev A call flow for an access terminal originating an HRPD session. However, the following description provides differences between a conventional HRPD EvDO Rev A call flow and embodiments of the present invention. FIG. 1 shows a call flow 100 of an embodiment of the authentication process of the present invention and is shown beginning at step 1 of a conventional HRPD EvDO Rev A call flow. Steps in FIG. 1 that correspond to steps in the conventional HRPD EvDO Rev A call flow are indicated by parenthetical letters in FIG. 1, where the parenthetical letters refer to the corresponding conventional HRPD EvDO Rev A steps. Following the conventional steps of (a) UATIRequest, (b) A14-UATI Request, (c) A14-UATI Assignment, (d) UATIAssignment, (e) UATIComplete, (f) A14-UATI Complete, (g) A14-UATI Complete Ack, (h) Connection Request, (i) A9-Setup-A8, 0) A9-Release-A8, and (k) TCH Establishment, the call flow 100 includes the step of negotiating an air link application layer packet-oriented protocol during (1) Session Negotiation, such as negotiating AN Auth Protocol for an HRPD EvDO Rev A access network session supporting multiflow packet application protocol. Then, following the additional conventional steps of (m) Connection Request, (n) A14-Session Info Update, (o) A14-Session Info Update Ack, (p) Connection Request, (q) TCH Establishment, (t) Location Update Procedure which is optional, (u) AT or AN indicates ready to exchange data on access stream, and (r) A14-Authentication Request, the call flow 100 includes the step of the SC/MM network entity 20, typically a PCF network entity 18, sending an A14 Authentication Challenge to the access network 14 for initiating authentication of the access terminal 12. The access network 14 sends an Access Network Authentication Challenge Request (ANAuthChallengeReq) message to the access terminal 12 using the packet-based link layer protocol negotiated between the access network 14 and the access terminal 12. The access terminal 12 sends an Access Network Authentication Challenge Response (AN AuthChallengeResp) message back to the access network 14. After receiving the ANAuthChallengeResp message, the access network 14 forwards the ANAuthChallengeResp message as an A14 Authentication Response message to the to the network entity 20 performing SC/MM functionality, typically the PCF network entity 18 but possibly an ANC. The conventional HRPD EvDO Rev A call flow defines an A14 Authentication Response message, but the A14 Authentication Response message of the exemplary embodiment of the present invention has different contents and flows in the opposite direction, i.e., it flows from the access network 14 to the network entity 20 performing SC/MM functionality and contains the AN Auth Challenge Response data, rather than flowing from the PCF to the access network in a conventional HRPD EvDO Rev A call flow. The network entity 20 receiving the A14 Authentication Response message then sends a conventional A12 Access Reauest message to the AN AAA server 30 and receives a conventional A12 Access Response message back from the AN AAA server 30. The A12 Access Response message confirms the authentication of the access terminal 12 on the access network 14 by the AN AAA 30. The network entity 20 performing SC/MM functionality then sends a conventional A14 Authentication Complete message to the access network 14. The access network 14 sends an Access Network Authorization Status Indication (ANAuthStatusInd) message to the access terminal 12 and a conventional A14 Authentication Completed Acknowledgment back to the network entity 20 performing SC/MM functionality. The ANAuthStatusInd message communicates the status of the A12 access request to the access terminal.

The access network 14 typically sets the MessageID of an ANAuthChallengeReq message to an unused value. The same identifier is used in the ANAuthChallengeResp and ANAuthStatusInd message and helps match the Access Network Authentication Challenge, Response, and Status Indication messages. The Challenge and Challenge Response Size and Value have the same meaning as in the CHAP protocol, which is available in PPP Challenge Handshake Authenticaiton Protocol (CHAP), RFC 1994 (August 1996). The channel may be set to forward traffic channel (FTC), SLP set to Reliable, and Addressing set to unicast for ANAuthChallengeReq messages; the channel may be set to reverse traffic channel (RTC), SLP set to Reliable, and Addressing set to unicast for ANAuthChallengeResp messages; and the channel may be set to FTC, SLP set to Reliable, and Addressing set to unicast for ANAuthSatusInd messages.

Alternatively, another embodiment of optimized access network authentication of the present invention will define functionality for access network authentication on top of a packet-based application layer protocol (i.e., packet-based RLP) during (1) Session Negotiation, such as defining functionality for access network authentication on top of packet-oriented RLP when operating on an enhanced HRPD EvDO Rev A access network supporting enhanced multiflow packet application protocol. The subsequent steps for performing access network authentication, otherwise performed by LCP and CHAP or performed using AN Auth Protocol, may be performed using messages defined for extended packet-oriented RLP similar to those described above with respect to AN Auth Protocol that provide the ability to communicate an authentication challenge and response to and from the access terminal and provide the access terminal with the status of the authentication performed at the AN AAA server.

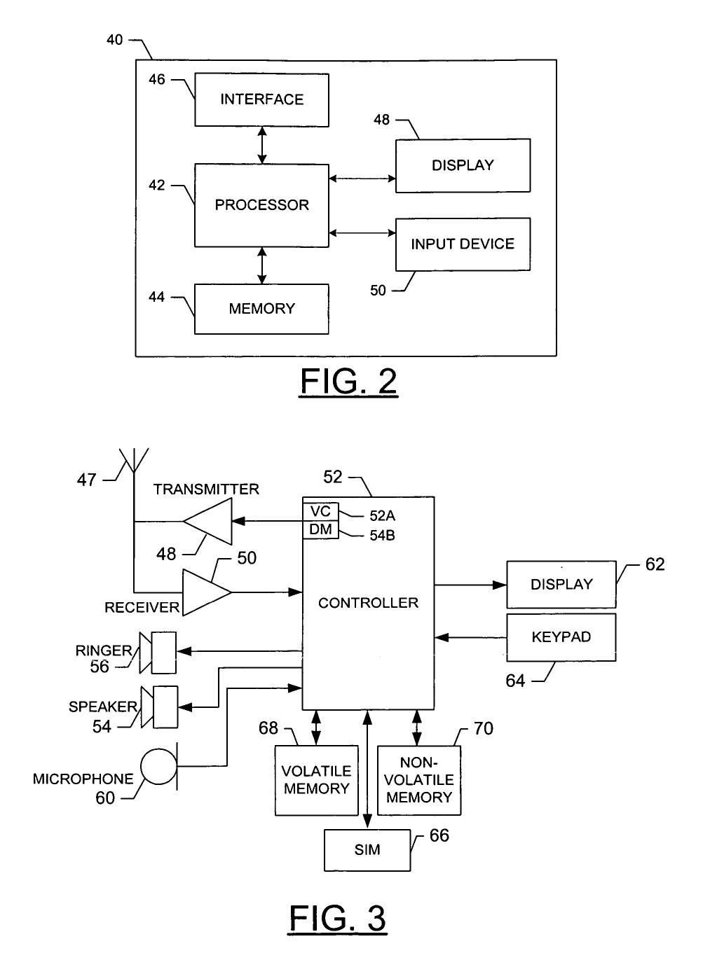

Reference is now made to FIG. 2, which illustrates a block diagram of an entity 40 capable of performing and/or facilitating optimized access network authentication of an embodiment of the present invention, such as an access terminal 12, access network or access network controller (ANC) 14, PCF network entity 18 or SC/MM network entity 20, or AN AAA server 30. Although generally shown as separate network entities, in some embodiments, the entity 40 may be a network node which is a combination of network entities, logically separated but co-located within one network node, to support optimized access network authentication, such as a combined ANC-PCF-SC/MM network entity. Similarly, a network entity may be embodied as hardware, software, or combinations of hardware and software components.

As shown, the entity 40 generally includes a processor, controller, or the like 42 connected to memory 44. The memory 44 can include volatile and/or non-volatile memory and typically stores content, data, or the like. For example, the memory 44 typically stores computer program code such as software applications or operating systems, information, data, content, or the like for the processor 42 to perform steps associated with operation of the entity in accordance with embodiments of the present invention. Also, for example, the memory 44 typically stores content transmitted from, or received by, the entity 40. Memory 44 may be, for example, random access memory (RAM), a hard drive, or other fixed data memory or storage device. The processor 42 may receive input from an input device 50 and may display information on a display 48. The processor 42 can also be connected to at least one interface 46 or other means for transmitting and/or receiving data, content, or the like. Where the entity 40 provides wireless communication, such as in a CDMA network, Bluetooth network, a wireless LAN network, or other mobile network, the processor 42 may operate with a wireless communication subsystem of the interface 46. One or more processors, memory, storage devices, and other computer elements may be used in common by a computer system and subsystems, as part of the same platform, or processors may be distributed between a computer system and subsystems, as parts of multiple platforms.

FIG. 3 illustrates a functional diagram of an access terminal, which may be a mobile device, mobile terminal, mobile station (MS), capable of performing and/or facilitating optimized access network authentication of an embodiment of the present invention. The access terminal shown in FIG. 3 is a more detailed depiction of one version of an entity 40 shown in FIG. 2. It should be understood, that the access terminal illustrated and hereinafter described is merely illustrative of one type of access terminal that would benefit from an embodiment of the present invention and, therefore, should not be taken to limit the scope of the present invention or the type of devices which may operate in accordance with the present invention. While several embodiments of the access terminal are hereinafter described for purposes of example, other types of access terminal, such as mobile phones, portable digital assistants (PDAs), pagers, laptop computers, and other types of voice and text communications systems, can readily be employed to function with the present invention.

The access terminal includes an antenna 47, a transmitter 48, a receiver 50, and a controller 52 that provides signals to and receives signals from the transmitter 48 and receiver 50, respectively. These signals include signaling information in accordance with the air interface standard of the applicable cellular system and also user speech and/or user generated data. In this regard, the access terminal can be capable of operating with one or more air interface standards, communication protocols, modulation types, and access types. More particularly, the access terminal can be capable of operating in accordance with any of a number of second-generation (2G), 2.5G and/or third-generation (3G) communication protocols or the like.

It is understood that the controller 52, such as a processor or the like, includes the circuitry required for implementing the video, audio, and logic functions of the access terminal. For example, the controller may be comprised of a digital signal processor device, a microprocessor device, and various analog to digital converters, digital to analog converters, and other support circuits. The control and signal processing functions of the access terminal are allocated between these devices according to their respective capabilities. The controller 52 thus also includes the functionality to convolutionally encode and interleave message and data prior to modulation and transmission. The controller 52 can additionally include an internal voice coder (VC) 52A, and may include an internal data modem (DM) 52B. Further, the controller 52 may include the functionality to operate one or more software applications, which may be stored in memory. For example, the controller may be capable of operating a connectivity program, such as a conventional Web browser. The connectivity program may then allow the access terminal to transmit and receive Web content, such as according to HTTP and/or the Wireless Application Protocol (WAP), for example.

The access terminal may also comprise a user interface such as including a conventional earphone or speaker 54, a ringer 56, a microphone 60, a display 62, all of which are coupled to the controller 52. The user input interface, which allows the access terminal to receive data, can comprise any of a number of devices allowing the access terminal to receive data, such as a keypad 64, a touch display (not shown), a microphone 60, or other input device. In embodiments including a keypad, the keypad can include the conventional numeric (0-9) and related keys (#, *), and other keys used for operating the access terminal and may include a full set of alphanumeric keys or set of keys that may be activated to provide a full set of alphanumeric keys. Although not shown, the access terminal may include a battery, such as a vibrating battery pack, for powering the various circuits that are required to operate the access terminal, as well as optionally providing mechanical vibration as a detectable output.

The access terminal can also include memory, such as a subscriber identity module (SIM) 66, a removable user identity module (R-UIM) (not shown), or the like, which typically stores information elements related to a mobile subscriber. In addition to the SIM, the access terminal can include other memory. In this regard, the access terminal can include volatile memory 68, as well as other non-volatile memory 70, which can be embedded and/or may be removable. For example, the other non-volatile memory may be embedded or removable multimedia memory cards (MMCs), Memory Sticks as manufactured by Sony Corporation, EEPROM, flash memory, hard disk, or the like. The memory can store any of a number of pieces or amount of information and data used by the access terminal to implement the functions of the access terminal. For example, the memory can store an identifier, such as an international mobile equipment identification (IMEI) code, international mobile subscriber identification (IMSI) code, mobile device integrated services digital network (MSISDN) code, or the like, capable of uniquely identifying the access terminal. The memory can also store content. The memory may, for example, store computer program code for an application, such as a software program or modules for an application, such as to perform and/or facilitate optimized access network authentication of an embodiment of the present invention, and may store an update for computer program code for the access terminal.

One of ordinary skill in the art will recognize that an embodiment of the present invention may be incorporated into hardware and software systems and subsystems, combinations of hardware systems and subsystems and software systems and subsystems, and incorporated into network systems and mobile stations thereof. In each of these systems and access terminal, as well as other systems capable of using a system or performing a method of an embodiment of the present invention as described above, the system and access terminal generally may include a computer system including one or more processors that are capable of operating under software control to provide the techniques described above, including performing and/or facilitating optimized access network authentication.

Computer program instructions for software control for embodiments of the present invention may be loaded onto a computer or other programmable apparatus to produce a machine, such that the instructions which execute on the computer or other programmable apparatus create means for implementing the functions described herein, such as an access terminal operating in accordance with optimized access network authentication of an embodiment of the present invention. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions described herein. It will also be understood that each step, and combinations of steps, can be implemented by hardware-based computer systems, software computer program instructions, or combinations of hardware and software which perform the specified functions or steps of performing and/or facilitating optimized access network authentication of an embodiment of the present invention.

Herein provided and described are improved systems, methods, devices, and computer program products for optimized access network authentication of an access terminal on an access network supporting negotiation of an application level protocol for the air link or implementing access network authentication functionality with an extended packet-oriented RLP. A packet-oriented air link application layer protocol supporting the functionality of CHAP authentication, such as an application level authentication protocol operating on an HRPD EvDO Rev A access network or an extended packet-oriented RLP operating on an enhanced HRPD EvDO Rev A access network, can be used for authenticating an access terminal on the access network without setting up a PPP session for access network authentication, such as setting up an air link stream for LCP and CHAP to support authentication. Embodiments of the present invention avoid the need for additional PPP setup for access network authentication, thus, saving air link resources and time during the authentication process for the access terminal and access network and, at the same time, reducing the complexity of access terminal implementations by avoiding the need for multiple PPP sessions by using one of the virtual streams to avoid the need to use one of the four physical streams defined in the HRPD system.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for authenticating an access terminal on an access network, comprising the steps of:
establishing a communication session between the access terminal and the access network;
negotiating the communication session, wherein the step of negotiating the communication session comprises the step of determining use of a protocol with network authentication functionality;
receiving an access network authentication challenge request message of the access network authentication protocol from the access network;
transmitting an access network authentication challenge response message of the access network authentication protocol to the access network; and
receiving an access network authentication status indication message of the access network authentication protocol from the access network.

2. The method of claim 1, wherein the step of determining use of a protocol with network authentication functionality comprises the step of negotiating an access network authentication protocol for the air link application layer.

3. The method of claim 2, wherein the step of negotiating an access network authentication protocol for the air link application layer comprises the step of defining a frame structure for the access network authentication protocol.

4. The method of claim 2, wherein the step of negotiating an access network authentication protocol for the air link application layer comprises the step of defining an access network authentication challenge request message and an access network authentication challenge response message for the access network authentication protocol.

5. The method of claim 4, wherein the step of negotiating an access network authentication protocol for the air link application layer further comprises the step of defining an access network status indication message for the access network authentication protocol.

6. The method of claim 1, wherein the step of determining use of a protocol with network authentication functionality comprises the step of implementing access network authentication functionality in an extended packet-based air link application layer protocol.

7. The method of claim 6, wherein the step of implementing access network authentication functionality in an extended packet-based air link application layer protocol comprises the step of incorporating an access network authentication challenge request message and an access network authentication challenge response message into the extended packet-based air link application layer protocol.

8. The method of claim 7, wherein the step of implementing access network authentication functionality in an extended packet-based air link application layer protocol further comprises the step of incorporating an access network status indication message into the extended packet-based air link application layer protocol.

9. The method of claim 1, wherein the access network authentication challenge request message from the access network comprises a message identification field set to an unused identifier value and wherein the step of transmitting an access network authentication challenge response message of the access network authentication protocol to the access network comprises setting a field of the access network authentication challenge response message to the unused identifier value used in the message identification field of the access network authentication challenge request message.

10. A method for authenticating an access terminal on an access network, comprising the steps of:
establishing a communication session between the access terminal and the access network;
negotiating the communication session, wherein the step of negotiating the communication session comprises the step of determining use of a protocol with network authentication functionality;
transmitting an access network authentication challenge request message of the access network authentication protocol to the access terminal;
receiving an access network authentication challenge response message of the access network authentication protocol from the access terminal; and
transmitting an access network authentication status indication message of the access network authentication protocol to the access terminal.

11. The method of claim 10, wherein the step of determining use of a protocol with network authentication functionality comprises the step of negotiating an access network authentication protocol for the air link application layer.

12. The method of claim 11, wherein the step of negotiating an access network authentication protocol for the air link application layer comprises the step of defining a frame structure for the access network authentication protocol.

13. The method of claim 11, wherein the step of negotiating an access network authentication protocol for the air link application layer comprises the step of defining an access network authentication challenge request message and an access network authentication challenge response message for the access network authentication protocol.

14. The method of claim 13, wherein the step of negotiating an access network authentication protocol for the air link application layer further comprises the step of defining an access network status indication message for the access network authentication protocol.

15. The method of claim 10, wherein the step of determining use of a protocol with network authentication functionality comprises the step of implementing access network authentication functionality in an extended packet-based air link application layer protocol.

16. The method of claim 15, wherein the step of implementing access network authentication functionality in an extended packet-based air link application layer protocol comprises the step of incorporating an access network authentication challenge request message and an access network authentication challenge response message into the extended packet-based air link application layer protocol.

17. The method of claim 16, wherein the step of implementing access network authentication functionality in an extended packet-based air link application layer protocol further comprises the step of incorporating an access network status indication message into the extended packet-based air link application layer protocol.

18. The method of claim 10, further comprising the steps of:
receiving an authentication challenge to authenticate the access terminal, wherein the step of transmitting an access network authentication challenge request message to the access terminal is in response to receiving the authentication challenge; and
transmitting an authentication response for authenticating the access terming, wherein the step of transmitting the authentication response is in response to receiving the access network authentication challenge response message from the access terminal.

19. The method of claim 10, wherein the step of transmitting an access network authentication challenge request message of the access network authentication protocol to the access terminal comprises setting a message identification field of the access network authentication challenge request message to an unused identifier value.

20. The method of claim 19, wherein the step of transmitting an access network authentication status indication message of the access network authentication protocol to the access terminal comprises setting a field of the access network authentication status indication message to the unused identifier value used in the message identification field of the access network authentication challenge request message.

21. An access terminal, comprising:
an interface capable of receiving and transmitting access network authentication messages, respectively, from and to an access network; and
a processing element capable of establishing a communication session with the access network by:
negotiating the communication session by determining use of a protocol with network authentication functionality;
receiving an access network authentication challenge request message of the access network authentication protocol from the access network;
transmitting an access network authentication challenge response message of the access network authentication protocol to the access network; and
receiving an access network authentication status indication message of the access network authentication protocol from the access network.

22. The access terminal of claim 21, wherein the processing element is further capable of negotiating an access network authentication protocol for the air link application layer for determining use of a protocol with network authentication functionality for negotiating the communication session for establishing a communication session with an access network.

23. The access terminal of claim 22, wherein the processing element is further capable of defining a frame structure for the access network authentication protocol for negotiating an access network authentication protocol for the air link application layer.

24. The access terminal of claim 21, wherein the processing element is further capable of implementing access network authentication functionality in an extended packet-based air link application layer protocol for determining use of a protocol with network authentication functionality for negotiating the communication session for establishing a communication session with an access network.

25. An network entity, comprising:
an interface capable of receiving and transmitting access network authentication messages, respectively, from and to an access terminal; and
a processing element capable of establishing a communication session with the access terminal by:
negotiating the communication session by determining use of a protocol with network authentication functionality;
transmitting an access network authentication challenge request message of the access network authentication protocol to the access terminal;
receiving an access network authentication challenge response message of the access network authentication protocol from the access terminal; and
transmitting an access network authentication status indication message of the access network authentication protocol to the access terminal.

26. The network entity of claim 25, wherein the processing element is further capable of negotiating an access network authentication protocol for the air link application layer for determining use of a protocol with network authentication functionality for negotiating the communication session for establishing a communication session with an access network.

27. The network entity of claim 26, wherein the processing element is further capable of defining a frame structure for the access network authentication protocol for negotiating an access network authentication protocol for the air link application layer.

28. The network entity of claim 25, wherein the processing element is further capable of implementing access network authentication functionality in an extended packet-based air link application layer protocol for determining use of a protocol with network authentication functionality for negotiating the communication session for establishing a communication session with an access network.

29. A computer program product for authenticating an access terminal on an access network, wherein the computer program product comprises a computer-readable storage medium having computer-readable program code embodied in the medium, and wherein the computer-readable program code comprises:
a first code for establishing a communication session between the access terminal and the access network;
a second code for negotiating the communication session, wherein the second code further comprises a sixth code for determining use of a protocol with network authentication functionality;
a third code for receiving an access network authentication challenge request message of the access network authentication protocol from the access network;
a fourth code for transmitting an access network authentication challenge response message of the access network authentication protocol to the access network; and
a fifth code for receiving an access network authentication status indication message of the access network authentication protocol from the access network.

30. The computer program product of claim 29, wherein the second code further comprises a seventh code for negotiating an access network authentication protocol for the air link application layer.

31. The computer program product of claim 30, wherein the seventh code comprises an eighth code for defining a frame structure for the access network authentication protocol.

32. The computer program product of claim 29, wherein the second code further comprises a ninth code for implementing access network authentication functionality in an extended packet-based air link application layer protocol.

33. A computer program product for authenticating an access terminal on an access network, wherein the computer program product comprises a computer-readable storage medium having computer-readable program code embodied in the medium, and wherein the computer-readable program code comprises:
a first code for establishing a communication session between the access terminal and the access network;
a second code for negotiating the communication session, wherein the second code further comprises a sixth code for determining use of a protocol with network authentication functionality;
a third code for transmitting an access network authentication challenge request message of the access network authentication protocol to the access terminal;
a fourth code for receiving an access network authentication challenge response message of the access network authentication protocol from the access terminal; and
a fifth code for transmitting an access network authentication status indication message of the access network authentication protocol to the access terminal.

34. The computer program product of claim 33, wherein the sixth code comprises a seventh code for negotiating an access network authentication protocol for the air link application layer.

35. The computer program product of claim 34, wherein the seventh code comprises an eighth code for defining a frame structure for the access network authentication protocol.

36. The computer program product of claim 33, wherein the sixth code comprises a ninth code for implementing access network authentication functionality in an extended packet-based air link application layer protocol.

37. The computer program product of claim 33, further comprising:
a tenth code for receiving an authentication challenge to authenticate the access terminal, wherein the transmission of an access network authentication challenge request message to the access terminal of the third code is in response to the reception of the authentication challenge of the tenth code; and
an eleventh code for transmitting an authentication response for authenticating the access terming, wherein the transmission of the authentication response of the eleventh code is in response to the reception of the access network authentication challenge response message from the access terminal of the fourth code.
